(19) United States
(12) Patent Application Publication
(10) Pub. No.: US 2009/0019749 A1
(43) Pub. Date: Jan. 22, 2009

(54) Tension device for attaching a flexible covering to a sign frame

(76) Inventor: Tully W. Fowler, Ottawa, KS (US)

Correspondence Address: HARSHAW RESEARCH, INC., 210 W. TECUMSEH STREET, OTTAWA, KS, 66067, US

(21) Appl. No.: 11/879,574

(22) Filed: Jul. 18, 2007

(51) Int. Cl. G09F 17/00

(52) U.S. Cl. 40/603

(57) ABSTRACT

A tension device for use in attaching a flexible covering to a sign frame includes a first end having a hook configuration for coupling the device to the flexible covering. The tension device includes a second end having a hook configuration for coupling the tension device to the sign frame. Further, the tension device includes a spring positioned between the first and second ends for maintaining tension between the first and second ends. A mounting loop is positioned between the first and second ends and configured to receive a leverage member for separating the first and second ends. The first end, spring, mounting loop, and second end include a singular metal construction. The spring is configured to expand and contract to maintain tension between the first and second ends when the flexible covering contracts and expands while the tension device is coupled to the flexible covering and the sign frame.

### BACKGROUND OF THE INVENTION

This invention relates to sign and display devices and, more particularly, to device for attaching a flexible covering to a sign frame.

It is becoming increasingly common for flexible fascia material to be attached to a sign frame, especially on the exterior of a commercial building. For example, banks, retail stores, restaurants, gas stations, and convenience stores may include signage containing indicia such as the company name or other advertising. The flexible covering may be attached after the frame is already installed and may be removable. Being able to remove the flexible covering is desirable where the covering includes temporary advertising indicia or when the business name has changed.

Harsh weather conditions, however, may cause the flexible material to expand or contract and become wrinkled, stretched out, or otherwise aesthetically undesirable. More particularly, the flexible material may expand or contract due to extreme temperatures in such a way as to degrade the quality or durability of the material. Manual retensioning of the flexible material is typically necessary to restore the original and desirable appearance of the material.

Various tension devices have been proposed in the art related to holding flexible sign covers to sign frames. Although assumably effective to hold the flexible coverings in a predetermined position, the existing devices are not particularly suitable for preventing damage caused by extreme weather conditions and do not provide a means for maintaining a desirable tension and appearance following transitions between extreme hot and cold temperatures.

Therefore, it would be desirable to have a tension device for attaching a flexible covering to a sign frame. Further, it would be desirable to have a tension member that enables a flexible covering to expand or contract during extreme temperature conditions and then to return to its normal configuration without manual re-tensioning. In addition, it would be desirable to have a tension member having a structure that makes connecting a flexible covering to a sign frame fast and easy.

### SUMMARY OF THE INVENTION

Accordingly, a tension device for use in attaching a flexible covering to a sign frame includes a first end having a structure for coupling the device to the flexible covering. The tension device includes a second end having a structure for coupling the tension device to the sign frame. Further, the tension device includes a spring positioned between the first and second ends for maintaining tension between the first and second ends. A mounting loop is positioned between the first and second ends that is configured to receive a leverage member for separating the first and second ends.

More particularly, the structure for coupling the tension device to the flexible covering includes a hook configuration. Similarly, the structure for coupling the tension device to the sign frame also includes a hook configuration. Preferably, the first end, spring, mounting loop, and second end include a singular metal construction. Further, the spring is configured to expand and contract to maintain tension between the first and second ends when the flexible covering contracts and expands while the tension device is coupled to the flexible covering and the sign frame.

Therefore, a general object of the present invention is to provide a tension device for use in attaching a flexible covering to a sign frame.

Another object of this invention is to provide a tension device, as aforesaid, that expands or contracts along with the expansion or contraction of the flexible covering due to extreme weather changes.

Still another object of this invention is to provide a tension device, as aforesaid, having a spring that returns the flexible covering to its original configuration after a contraction or expansion due to extreme weather without requiring manual re-tensioning.

Yet another object of this invention is to provide a tension device, as aforesaid, having a mounting loop that enables the tension member to be expanded for quick and easing mounting to a flexible covering and sign frame.

A further object of this invention is to provide a tension device, as aforesaid, in which opposed ends, spring, and mounting loop include a singular metal construction.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a tension device according to a preferred embodiment of the present invention;

FIG. 2a is a perspective view of multiple tension devices in use with a sign frame;

FIG. 2b is an isolated view on an enlarged scale taken from a portion of FIG. 2a illustrating the tension device in an uninstalled configuration;

FIG. 3 is another isolated view as in FIG. 2b illustrating the tension device in a partially installed configuration; and

FIG. 4 is another isolated view as in FIG. 2b illustrating the tension device in a completely installed configuration.

### DESCRIPTION OF THE PREFERRED EMBODIMENT

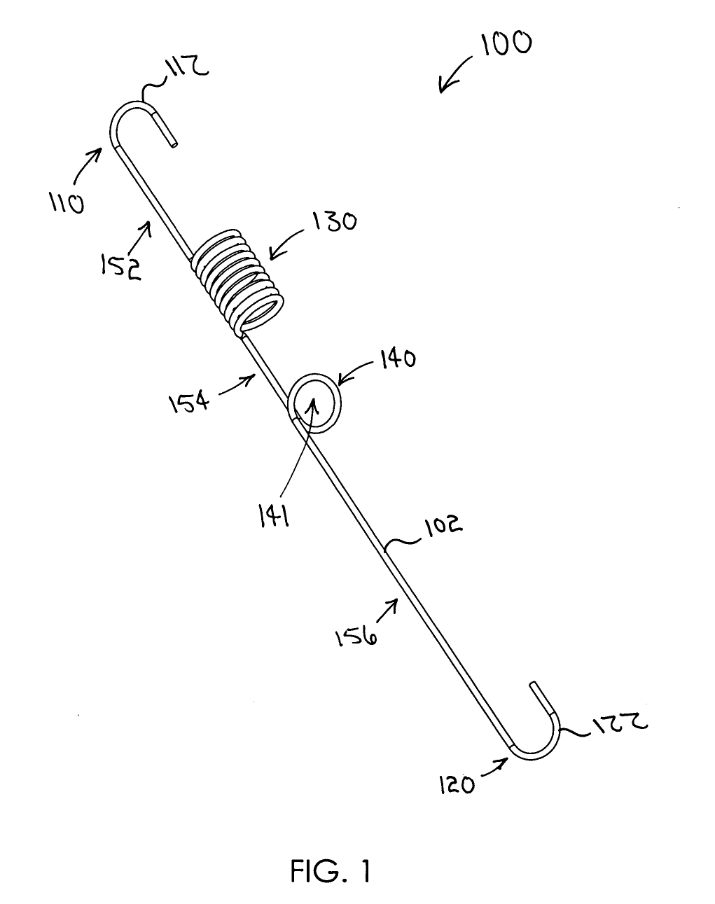

A tension device 100 according to the present invention will now be described in detail with reference to FIGS. 1 through 4 of the accompanying drawings. More particularly, according to the current invention, a tension device 100 for use in attaching a flexible covering 10 (which may include indicia such as advertising indicia) to a sign frame 20 and maintaining the flexible covering 10 in tension regardless of weather changes includes first and second ends 110, 120, a spring 130, and a mounting loop 140.

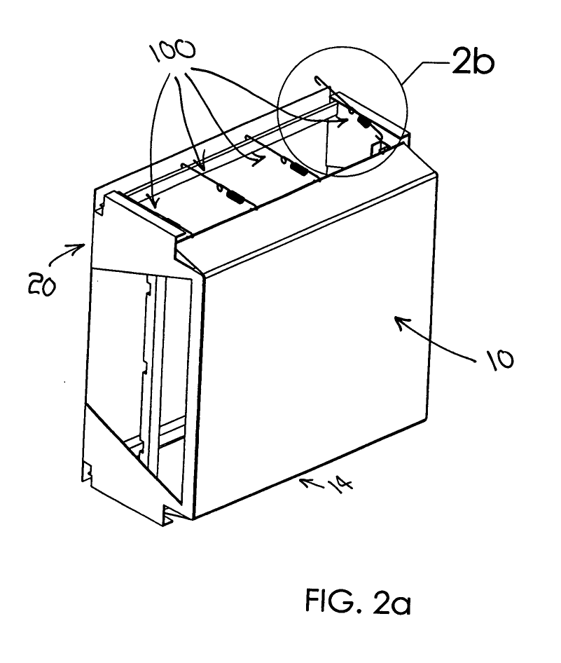

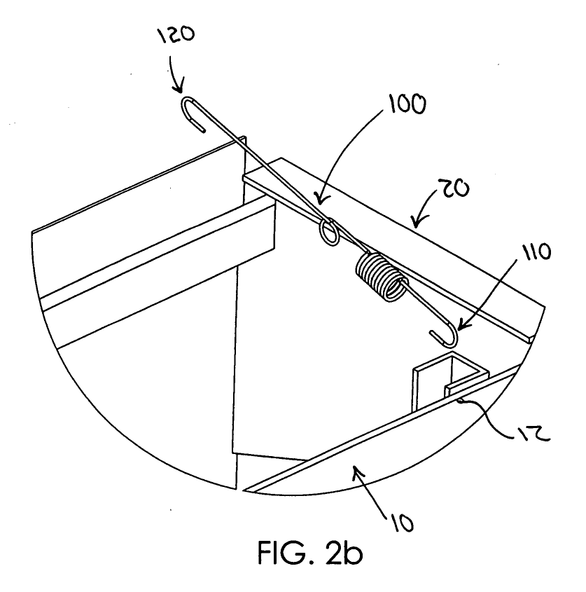

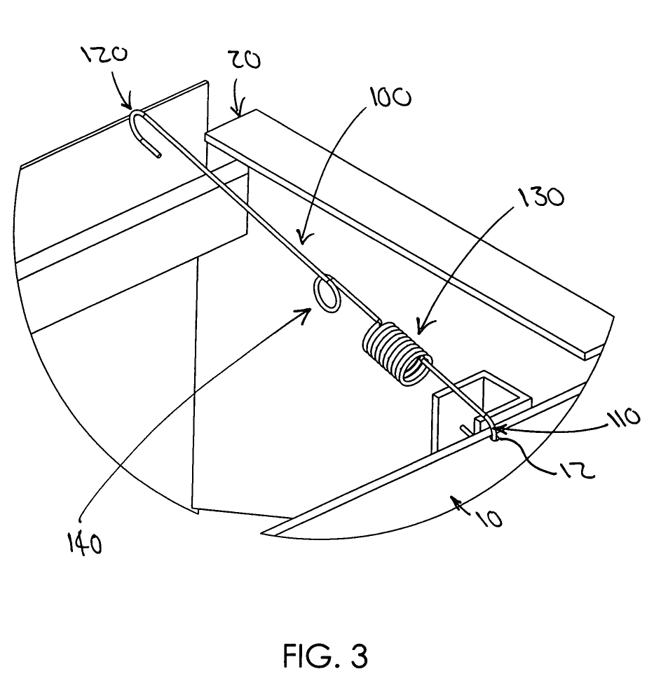

The first end 110 includes means for coupling the tension device 100 to the flexible covering 10. More particularly, as shown in FIG. 1, the first end 110 may have an arcuate or “hook” configuration 112 for coupling the tension device 100 to the flexible covering 10. The hook 112 may be configured to pass through an eyelet 12 of the flexible covering 10 (FIGS. 2b and 3) or to pass through the flexible covering itself (i.e., by puncturing the flexible covering 10). Alternately, the first end 110 may include a clip or other fastener appropriate for attaching to the flexible covering 10. While other fasteners may be used, the hook 112 may be preferable for cost and manufacturing considerations.

The second end 120 includes means for coupling the tension device 100 to the sign frame 20 (e.g., a sign frame typically used to support flexible coverings). More particularly, as shown in FIG. 1, the second end 120 may have an arcuate or “hook” configuration 122 for coupling the tension device 100 to the sign frame 20, as shown in FIG. 2a. Alternately, the second end 120 may include a clip or other fastener appropriate for attaching to the sign frame 20. While other fasteners may be used, the hook 122 may be preferable for cost and manufacturing considerations. As shown in FIG. 1, the first end hook 112 and the second end hook 122 may be generally coplanar. In other words, the hooks 112, 122 may be angled relative to the rest of the tension device 100 so that both hooks 112, 122 face in the same basic direction (preferably within about twenty degrees of each other and even more preferably within about fifteen degrees of each other).

The spring 130 is between the first and second ends 110, 120 to maintain tension between the first and second ends 110, 120. More particularly, the spring 130 is included to maintain the flexible covering 10 in tension when the first end 110 is coupled to the flexible covering 10 and the second end 120 is coupled to the sign frame 20. The spring 130 is configured as shown in FIG. 1 to expand and contract to maintain tension between the first and second ends 110, 120 when the flexible covering 10 contracts and expands (e.g., due to changing weather conditions) while the tension device 100 is coupled to the flexible covering 10 and the sign frame 20 as described above. In other words, the spring 130 may have a center axis (not shown) that is generally parallel to the length of the tension device 100.

The mounting loop 140 is between the first and second ends 110, 120 and is configured to receive a leverage member (e.g., a screwdriver, awl, etc.) for separating the first and second ends 110, 120 when the first end 110 is coupled to the flexible covering 10 and/or when the second end 120 is coupled to the sign frame 20. As shown in FIG. 1, the mounting loop 140 may define an opening 141 that is generally perpendicular to the center axis of the spring 130 discussed above. Though FIG. 1 shows the mounting loop 140 between the spring 130 and the second end 120, the mounting loop 140 may alternately be positioned between the spring 130 and the first end 110.

A single piece of metal may define the first end 110, the second end 120, the spring 130, and the mounting loop 140. For example, a single metal wire 102 may be bent to define the first end 110, the second end 120, the spring 130, and the mounting loop 140. As shown in FIG. 1, the wire 102 may define a generally linear portion 152 between the first end 110 and the spring 130 (or the mounting loop 140 if the mounting loop 140 is between the first end 110 and the spring 130), a generally linear portion 154 between the spring 130 and the mounting loop 140, and a generally linear portion 156 between the second end 120 and the mounting loop 140 (or the spring 130 if the mounting loop 140 is between the first end 110 and the spring 130). The generally linear portions 152, 154, 156 may lie generally adjacent a common axis (not shown), or in other words, the generally linear portions 152, 154, 156 may be combined and extended to form a line that is more or less straight. It should be understood that forming a line that is truly straight is not required; for example, it is clear from the construction of the mounting loop 140 shown in FIG. 1 that the portions 152, 154, 156 may be somewhat offset, and the portions 152, 154, 156 may additionally be slightly angled relative to one another (non-parallel).

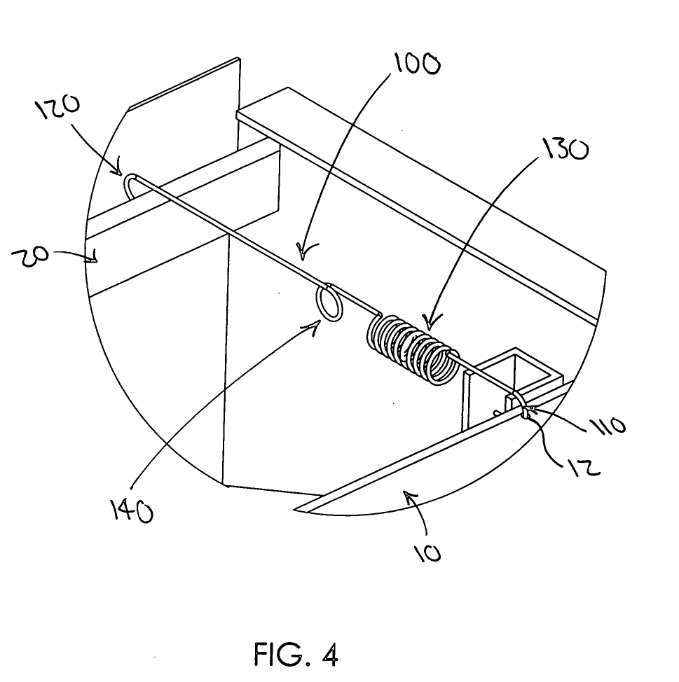

In use, the first end 110 may be coupled to the flexible covering 10 (e.g., by hook 112 passing through eyelet 12) as shown in FIG. 3. A user may then insert a leverage member (e.g., a screwdriver, awl, etc.) into the mounting loop opening 141 and physically extend or “stretch” the spring 130. While the spring 130 is extended, the second end 120 may be coupled to the sign frame 20 as shown in FIG. 4. Notably, a customized sign frame is not necessary, which allows the tension device 100 to be used with existing sign frames. A side 14 (FIG. 2a) of the flexible covering 10 that is opposite the side with the eyelets 12 may be similarly coupled to the sign frame 20 with tension devices 100 or with traditional fasteners such as clips, clamps, etc. The configuration of the tension device 100 described above may allow both ends 110, 120 to be easily and securely coupled to the respective items (i.e., flexible covering 10 and sign frame 20), the spring 130 to extend and contract, and the mounting loop 140 to provide a sturdy leverage point. In addition, when coupling the flexible covering 10 to the sign frame 20, the spring 130 may maintain tension on the flexible covering 10 regardless of weather conditions and material expansion/contraction. This constant tension may remove the need for retensioning the flexible covering 10 on the sign frame 20 by hand, which is generally required in the prior art and consumes time and energy.

It is understood that while certain forms of this invention have been illustrated and described, it is not limited thereto except insofar as such limitations are included in the following claims and allowable functional equivalents thereof.

1. A tension device for use in attaching a flexible covering to a sign frame, said tension device comprising:
a first end having means for coupling said tension device to said flexible covering;
a second end having means for coupling said tension device to said sign frame;
a spring between said first and second ends to maintain tension between said first and second ends; and
a mounting loop between said first and second ends, said mounting loop being configured to receive a leverage member for separating said first and second ends.

2. The tension device as in claim 1, wherein:
said means for coupling said tension device to said flexible covering includes a hook configuration; and
said means for coupling said tension device to said sign frame includes a hook configuration.

3. The tension device as in claim 2, wherein a single piece of metal defines said first end, said spring, said mounting loop; and said second end.

4. The tension device as in claim 1, wherein said spring is configured to expand and contract to maintain tension between said first and second ends when said flexible covering contracts and expands while said tension device is coupled to said flexible covering and said sign frame.

5. The tension device as in claim 1, wherein said leverage member is an awl.

6. The tension device as in claim 1, wherein said leverage member is a screwdriver.

7. The tension device as in claim 1, wherein:
said spring has a center axis; and
said mounting loop defines an opening generally perpendicular to said spring center axis.

8. A tension device for use in attaching a flexible covering to a sign frame and maintaining said flexible covering in tension regardless of weather changes, said tension device comprising:
a first end defining a hook for coupling said tension device to said flexible covering;
a second end defining a hook for coupling said tension device to said sign frame;
a spring between said first and second ends to maintain said flexible covering in tension when said first end is coupled to said flexible covering and said second end is coupled to said sign frame; and
a mounting loop between said first and second ends, said mounting loop being configured to receive a leverage member for separating said first and second ends when coupling at least one of said first end to said flexible covering and said second end to said sign frame.

9. The tension device as in claim 8, wherein a single piece of metal defines said first end, said spring, said mounting loop; and said second end.

10. The tension device as in claim 8, wherein a metal wire is bent to define said first end, said second end, said spring, and said mounting loop.

11. The tension device as in claim 10, wherein:
said wire has a first generally linear portion between said first end hook and said spring;
said wire has a second generally linear portion between said spring and said mounting loop;
said wire has a third generally linear portion between said mounting loop and said second end hook; and
said first, second, and third generally linear portions lie generally adjacent a common axis.

12. The tension device as in claim 8, wherein said first end hook and said second end hook are generally coplanar.

13. The tension device as in claim 8, wherein said first end hook, said second end hook, and said mounting loop are generally coplanar.

14. The tension device as in claim 8, wherein said first end hook is configured to pass through at least one of said flexible covering and an eyelet of said flexible covering to couple said tension device to said flexible covering.

15. The tension device as in claim 8, wherein:
said spring has a center axis; and
said mounting loop defines an opening generally perpendicular to said spring center axis.

16. A tension device for use in attaching a flexible covering to a sign frame and maintaining said flexible covering in tension regardless of weather changes, said tension device comprising:
an arcuate first end for coupling said tension device to said flexible covering;
an arcuate second end for coupling said tension device to said sign frame;
a spring between said first and second ends to maintain said flexible covering in tension when said first end is coupled to said flexible covering and said second end is coupled to said sign frame;
a mounting loop between said first and second ends, said mounting loop being configured to receive a leverage member for separating said first and second ends when coupling at least one of said first end to said flexible covering and said second end to said sign frame;
a first generally linear portion between said first end and one of said spring and said mounting loop;
a second generally linear portion between said second end and one of said spring and said mounting loop;
wherein said first and second generally linear portions lie generally adjacent a common axis.

17. The tension device as in claim 16, wherein a metal wire is bent to define said arcuate first end, said arcuate second end, said spring, and said mounting loop.

18. The tension device as in claim 16, wherein:
said spring has a center axis; and
said mounting loop defines an opening generally perpendicular to said spring center axis.

19. The tension device as in claim 18, wherein said arcuate first end and said arcuate second end are generally coplanar.

20. The tension device as in claim 19, wherein said leverage member is a screwdriver.
